(19) United States
(12) Patent Application Publication
(10) Pub. No.: US 2021/0192192 A1
(43) Pub. Date: Jun. 24, 2021

(54) METHOD AND APPARATUS FOR RECOGNIZING FACIAL EXPRESSION

(71) Applicant: BEIJING DAJIA INTERNET INFORMATION TECHNOLOGY CO., LTD., Beijing (CN)

(72) Inventors: Yan Li, Beijing (CN); Xuanping Li, Beijing (CN)

(21) Appl. No.: 17/121,902

(22) Filed: Dec. 15, 2020

(30) Foreign Application Priority Data
Dec. 20, 2019 (CN) 201911329050.3

(51) Int. Cl. G06K 9/00; G06T 17/00; G06T 13/40; G06N 3/02

(52) U.S. Cl. CPC G06K 9/00302; G06K 9/00281; G06N 3/02; G06T 17/00; G06T 13/40; G06K 9/00248

(57) ABSTRACT

A method and an apparatus for facial expression recognition is provided. A terminal device may obtain a face image by detecting an inputted image, determine expression classifications in the face image based on an expression classification standard, obtain expression coefficients of the expression classifications, and recognize expressions in the face image based on the expression coefficients.

### CROSS-REFERENCE TO RELATED APPLICATION

The present application is based on and claim priority under 35 U.S.C. 119 to Chinese Patent Application No. 201911329050.3, filed with the China National Intellectual Property Administration on Dec. 20, 2019, the disclosures of which are herein incorporated by reference in its entirety.

### TECHNICAL FIELD

The present disclosure relates to a field of image recognition technologies, and more particularly, to a method and an apparatus for facial expression recognition, and a non-transitory computer-readable storage medium.

### BACKGROUND

Facial expression recognition refers to the process of using a computer to extract facial expression features of a detected face, so that the computer may understand and process facial expressions correspondingly according to knowledge and understanding, and make response to people's needs to establish a friendly and intelligent-computer interaction environment.

Currently, facial animation driving (e.g., animoji or kmoji) is an application scenario of facial expression recognition technologies. Through facial animation driving, an expression of a three-dimensional avatar is driven to change correspondingly according to facial expression changes. Therefore, by driving the three-dimensional avatar, a good computer interaction effect may be achieved.

### SUMMARY

The present disclosure provides a method and an apparatus for facial expression recognition, and a non-transitory computer-readable storage medium. The technical solutions are provided as follows.

Embodiments of the present disclosure provide a method for facial expression recognition. The method includes: obtaining a face image by detecting an inputted image; determining expression classifications in the face image based on an expression classification standard; obtaining expression coefficients of the expression classifications; and recognizing expressions in the face image based on the expression coefficients.

Embodiments of the present disclosure provide an apparatus for facial expression recognition. The apparatus includes: one or more processors; a memory coupled to the one or more processors, and a plurality of instructions stored in the memory. When the plurality of instructions are executed by the one or more processors, the one or more processors are caused to perform acts including: obtaining a face image by detecting an inputted image; determining expression classifications in the face image based on an expression classification standard; obtaining expression coefficients of the expression classifications; and recognizing expressions in the face image based on the expression coefficients.

Embodiments of the present disclosure provide a non-transitory computer-readable storage medium. When an instruction stored in the non-transitory computer-readable storage medium is executed by a processor in an electronic device, the processor is caused to perform acts including: obtaining a face image by detecting an inputted image; determining expression classifications in the face image based on an expression classification standard; obtaining expression coefficients of the expression classifications; and recognizing expressions in the face image based on the expression coefficients.

It should be understood that the above general description and the following detailed description are only exemplary and explanatory, and cannot limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and should not be construed to unduly limit this disclosure.

FIG. 1 is a flowchart of a method for facial expression recognition according to an embodiment.

FIG. 2 is a flowchart of a method for facial expression recognition according to another embodiment.

FIG. 3 is a flowchart of a method for facial expression recognition according to yet another embodiment.

FIG. 4 is a block diagram of an apparatus for facial expression recognition according to an exemplary embodiment.

FIG. 5 is a block diagram of an apparatus for facial expression recognition according to an embodiment.

FIG. 6 is a block diagram of an electronic device according to an embodiment.

### DETAILED DESCRIPTION

In order to enable those skilled in the art to better understand the technical solution of the present disclosure, the technical solution in the embodiments of the present disclosure will be described clearly and completely with reference to the accompanying drawings.

It should be noted that the terms “first” and “second” in the specification and claims of the present disclosure and the above-mentioned drawings are used to distinguish similar objects, and not necessarily used to describe a specific sequence or precedence order. It should be understood that the data used in this way can be interchanged under proper circumstances, so that the embodiments of the present disclosure described herein can be implemented in an order other than those illustrated or described herein. The implementations described in the following exemplary embodiments do not represent all implementations consistent with the present disclosure. Rather, those implementations are merely examples of devices and methods consistent with some aspects of the present disclosure as detailed in the appended claims.

In order to overcome problems such as low accuracy and low efficiency for facial expression recognition in the prior art, embodiments of the present disclosure provide solutions for facial expression recognition. The present disclosure has the following beneficial effects.

In the technical solution according to the embodiments of the present disclosure, when an inputted image is received, face detection is performed on the image to obtain a face image. Based on an expression classification standard, each expression in the face image is determined. Then, for different types of expressions, different modes are applied to obtain expression coefficients of the types of expressions of a face in the face image. The expression of the face may be recognized based on values of the expression coefficients of the face. Therefore, according to the features of different types of expressions, the expression coefficients of the types of expressions are obtained in different modes, which improves the accuracy of expression recognition.

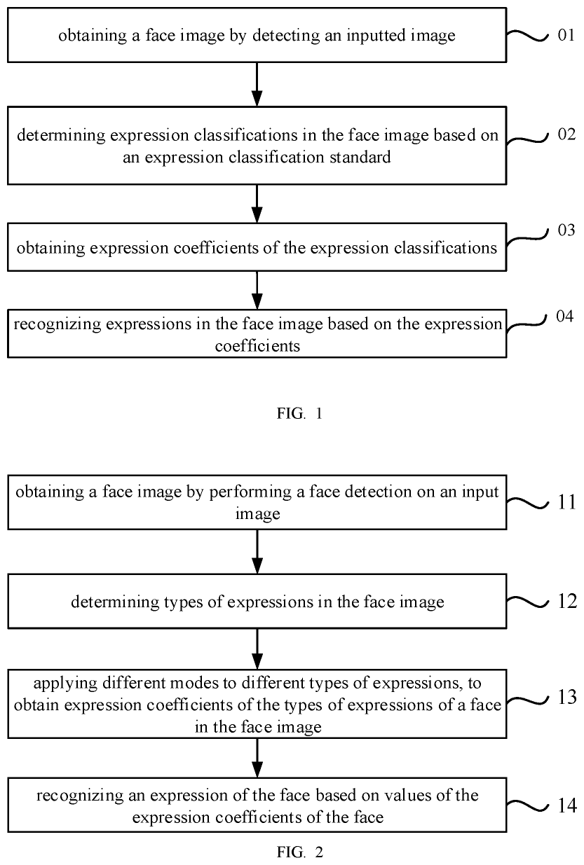

FIG. 1 is a flowchart of a method for facial expression recognition according to an embodiment. FIG. 1 provides an overview of the solution of the present disclosure. An execution subject of the method according to this embodiment may be an apparatus for facial expression recognition according to the embodiment of the disclosure. The apparatus may be integrated in a mobile terminal device (for example, a smart phone, and a tablet computer), a notebook or a fixed terminal (desktop computer), and the apparatus for facial expression recognition may be implemented by hardware or software. As illustrated in FIG. 1, the method includes the following steps.

At 01, a face image is obtained by detecting an inputted image.

At 02, expression classifications in the face image are determined based on an expression classification standard.

At 03, expression coefficients of the expression classifications are obtained.

At 04, expressions in the face image are recognized based on the expression coefficients.

Methods according to embodiments of the present disclosure will be further described in detail below.

FIG. 2 is a flowchart of a method for facial expression recognition according to another embodiment. An execution subject of the method for facial expression recognition according to some embodiments may be an apparatus for facial expression recognition according to some embodiments of the disclosure. The apparatus may be integrated in a mobile terminal device (for example, a smart phone, and a tablet computer), a notebook or a fixed terminal (desktop computer), and the apparatus for facial expression recognition may be implemented by hardware or software. As illustrated in FIG. 2, the method includes the following steps.

At 11, a face image is obtained by performing face detection on an inputted image.

In practical applications, the inputted image may not only contain faces, but also other objects. Therefore, in some embodiments, a face detection algorithm may be used to detect faces in the inputted image, locate the key feature points of the face, and cut out a face area from the inputted image. The face detection algorithm may be any face detection algorithm in the related art, such as a template matching method, a singular value feature method, a subspace analysis method, and a local preserving and projection method, which is not limited herein.

At 12, expressions classifications in the face image are determined based on an expression classification standard.

At 13, for different expressions classifications, different modes are applied to obtain expression coefficients of the expressions classifications of a face in the face image.

At 14, an expression of the face is recognized based on values of the expression coefficients of the face.

In the related art, when facial expressions are obtained, all facial expressions of the face are obtained in the same way. In fact, different facial expressions may have different features, a certain mode used to obtain expression coefficients of the face may be suitable for some expressions, but may be inappropriate for other expressions.

For example, with face 3D Morphable Model (3DMM) technology, three-dimensional modeling of the face in the face image is performed by using a pre-established three-dimensional facial expression database. Firstly, face feature point information is detected in real time, and a three-dimensional face with individual features and expression coefficients is reconstructed by solving a solution optimization, so that the expression coefficient of the face can be obtained. The 3DMM technology is applied to obtain the expression coefficients of the expressions of the face in the face image. For most expressions involving only one action unit, the expression coefficients obtained in this way are more accurate, but in the solution optimization process, the individual features and the expression coefficients of the face are easily coupled. For example, the eyes are relatively small individual features. Therefore, the eyes are easily coupled with closed eyes, so that the expression coefficients of such expressions cannot be accurately obtained.

Therefore, in some embodiments, according to the classification of the expressions in the face image, the expression coefficients of the different expressions classifications of the face are obtained in different modes for different expressions classifications, and based on the values of the expression coefficients, facial expressions are recognized. Therefore, according to the features of different expressions classifications, the expression coefficients of the different expressions classifications may be obtained in different modes, which improves the accuracy of expression recognition.

In order to describe a correspondence between different facial muscle actions and different expressions, psychologists Paul Ekman and W. V. Friesen proposed a facial action coding system (FACS). According to features of anatomy, the system is divided into a plurality of independent and interrelated action units, namely action units (AU), such as inner brow raiser (AU1) and outer brow raiser (AU2). Therefore, in some embodiments, the expressions in the face image are classified according to the facial action unit (AU) involving the expression.

For example, in some embodiments, different types of expressions include single-type expressions, and each single-type expression refers to an expression involving a single action unit and a single individual feature of the face. In some embodiments, the single-type expressions refer to expressions that are easily coupled with individual features, including but not limited to: opening eyes, closing eyes, opening mouth, and closing mouth. In some embodiments, by setting the expressions that are easily coupled with individual features as the single-type expressions, the expression coefficients of the expressions are calculated through the information of each feature point of the face, which may improve the accuracy of the expression coefficients of the expressions classifications.

In some embodiments, the step 13 may include the followings.

At 131, recognition is performed on the face image, and a plurality of feature points of the face in the face image are obtained.

In some embodiments, by using a facial feature point detection algorithm to detect facial feature points, key areas of the face can be located, including eyebrows, eyes, nose, mouth, and facial contours, to obtain feature point information of each key area.

In some embodiments, the facial feature point detection algorithm may be any facial feature point detection algorithm in the related art, for example, methods based on models such as active shape model (ASM) and active appearance model (AAM), cascading methods, for example, a method based on cascaded pose regression (CPR) algorithm, and deep learning methods, such as OpenFace, which is not specifically limited herein.

At 132, the individual feature related to the respective single-type expression is determined, and the expression coefficient of the respective single-type expression of the face is obtained based on feature points of the individual feature.

Through the foregoing implementations, the expression coefficients of the single-type expressions are obtained based on the feature points of the individual features, which improves the accuracy of the expression coefficients of the expressions classifications.

In some embodiments, each single-type expression involves eyes and mouth on the face respectively. Therefore, in order to simplify the way of obtaining the expression coefficient of the respective single-type expression, step 132 may include: obtaining the expression coefficient of the respective single-type expression by calculating a first degree based on coordinate values of the feature points of the individual feature, in which the first degree includes an opening or closing degree of the individual feature on the face involved by the respective single-type expression. That is, in some embodiments, the opening and closing degree of the individual features involving each single-type expression is used to represent the expression coefficient of each single-type expression, so that the expression coefficient of each single-type expression of the face may be calculated simply and accurately.

For example, at 132, four feature point information of the upper, lower, left, and right corners of the left eye in the feature point information of the face may be used to calculate the opening and closing degree of the left eye of the face, and four feature point information of the upper, lower, left, and right corners of the right eye in the feature point information of the face may be used to calculate the opening and closing degree of the right eye of the face, to obtain the expression coefficient of the face with open eyes and the expression coefficient of the face with closed eyes. Moreover, four feature point information of the upper, lower, left, and right corners of the mouth in the feature point information of the face may be used to calculate the opening and closing degree of the mouth of the face, to obtain the expression coefficient of the face with an opened mouth and the expression coefficient of the face with a closed mouth.

For example, taking the left eye as an example, coordinates of four feature point information of the upper, lower, left, and right corners of the left eye are (x1, y1) (x2, y2) (x3, y3), and (x4, y4), then the opening degree of the left eye is:

alpha1=((x1-x2)2+(y1-y2)2)0.5/((x3-x4)2+(y3-y4)2)0.5

In addition, in some embodiments, different expressions classifications include: subtle expressions, the subtle expressions refer to expressions other than the single-type expressions in expressions each involving the single action unit. In some embodiments, subtle expressions include, but are not limited to: raised eyebrows, frown, grin, crooked mouth, and twisted mouth. In some embodiments, step 13 may further include the followings.

At 133, a three-dimensional reconstruction is performed on the face in the face image by using a three-dimensional face reconstruction method based on the plurality of the feature points of the face, to obtain expression coefficients of the subtle expressions of the face.

In the above-mentioned implementations, a three-dimensional face with individual features and expression coefficients of the face is reconstructed through three-dimensional reconstruction solution optimization, so that the expression coefficients of the subtle expressions of the face are obtained.

In specific applications, the three-dimensional face reconstruction method may be any three-dimensional reconstruction solution optimization technology in the related art, for example, 3D morphable model (3DMM) technology. Through the 3DMM technology, the face model may be expressed linearly. For example, the reconstructed three-dimensional face model SnewModel may be solved by the following formula:

$${S}_{newModel} = \overline{S} + {\sum }_{i = 1}^{m - 1} {α}_{i} {s}_{i} + {\sum }_{i = 1}^{n - 1} {β}_{i} {e}_{i}$$

where S̅ represents an average face model, sᵢ represents the individual features of the face, αᵢ represents the coefficients corresponding to each individual feature, eᵢ represents the corresponding expression, and βᵢ represents the corresponding expression coefficient.

Through the three-dimensional face solution optimization, the expression coefficients of the subtle expressions may be obtained.

In practical applications, there is also an expression classification, such as anger, bulge and other expressions involving a plurality of motion units. Such expressions are related to facial textures and cannot be recognized through 3D reconstruction solution optimization, and such expressions also cannot be calculated directly based on the feature point information. In some embodiments, this expression classification is referred to as composite expressions. The expression coefficients of the complex expressions can be obtained through deep neural network models. Therefore, in some embodiments, step 13 may also include the followings.

At 134, the expression coefficient is obtained by inputting the face image into a target deep neural network model.

That is, the face image is input into trained target deep neural network models respectively to obtain expression coefficients of the composite expressions of the face, in which each target deep neural network model is corresponding to one composite expression, and each target deep neural network model is configured to identify the expression coefficient of the composite expression corresponding to the target deep neural network model.

In some embodiments, the target deep neural network model is trained by inputting collected face images into a deep neural network model corresponding to the composite expression and using a determining result on whether the collected face images contain the composite expression.

That is, in some embodiments, for each composite expression, a deep neural network model for facial expression recognition is trained correspondingly, and the face image is input to the corresponding deep neural network model to obtain the expression coefficients of the composite expressions. In some embodiments, the expression coefficients of the composite expressions are obtained, so that the expression coefficients of the face are obtained more completely.

In practical applications, in order to obtain a deep neural network model that can accurately recognize each composite expression, before 13, the method further includes: for any one of the composite expressions, constructing a corresponding deep neural network model, collecting a plurality of face images, and inputting the collected face images into the deep neural network model corresponding to the composite expression, and training the deep neural network model by using a determining result on whether the face in the face image has the composite expression as an output of the deep neural network model, to obtain a trained target deep neural network model. That is, in some embodiments, for each composite expression, a plurality of face images are collected, and according to the determined result on whether the face in the face image has the composite expression, the deep neural network model corresponding to the composite expression is trained to obtain the trained deep neural network model corresponding to the composite expression. For example, for anger, N face images are collected, and it is determined whether the face in the face image has the composite expression, for anger, 1 is marked, otherwise 0 is marked, and the N face images are input to the deep neural network model used to recognize anger to train the deep neural network model.

In some embodiments, the composite expressions include, but are not limited to: anger, bulge, and smile.

After the expression coefficients of the expressions are obtained, the three-dimensional face model obtained by the three-dimensional reconstruction is optimized according to the obtained expression coefficients, so that the three-dimensional face model can more realistically express the expression of the face on the face image. Therefore, in some embodiments, after recognizing the expression of the face based on the expression coefficients of the face, the method may further include: optimizing a three-dimensional face model of the face obtained through a three-dimensional reconstruction, based on the expression coefficients of the face. Therefore, the three-dimensional face model may present an expression corresponding to the facial expression on the face image, which increases the realism of the virtual three-dimensional face model, and can obtain information such as emotion of a target person in the face image accordingly.

In some embodiments, after recognizing the expression of the face based on the expression coefficients of the face, the method may further include: driving an avatar to make a corresponding expression according to the expression coefficients of the face. Through some embodiments, the user may drive the avatar through the camera to make corresponding expressions, which enriches user experience.

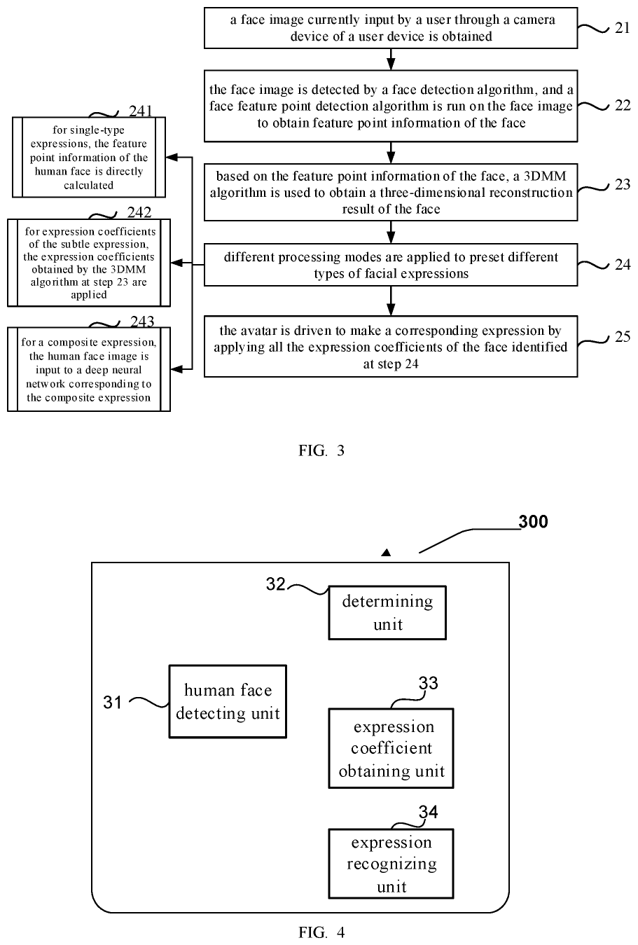

FIG. 3 is a flowchart of a method for facial expression recognition according to yet another embodiment. As illustrated in FIG. 3, this method is used in user device and mainly includes the following steps.

At 21, a face image currently input by a user through a camera device of a user device is obtained.

The user can input the face image through the build-in camera device (for example, a camera) of the user device, or a camera device connected to the user device.

At 22, the face image is detected by a face detection algorithm, and a face feature point detection algorithm is run on the face image to obtain feature point information of the face.

At 23, based on the feature point information of the face, a 3DMM algorithm is used to obtain a three-dimensional reconstruction result of the face, and at the same time, the expression coefficients of the subtle expressions of the face are obtained, and a head posture is obtained by solution optimization.

At 24, different processing modes are applied to different facial expressions classifications. In some embodiments, facial expressions are divided into three categories: single-type expressions, subtle expressions (also referred to as subtle-type expressions), and composite expressions.

At 241, for single-type expressions, such as four expressions of opening/closing eyes and opening/closing mouth, the feature point information of the face is directly calculated.

For closed eyes, eye landmarks are used to calculate the opening and closing degree of the eyes, thereby calculating the coefficient of closed eyes. Taking the left eye as an example, coordinates of four feature point information of the upper, lower, left, and right corners of the left eye are (x₁,y₁), (x₂,y₂), (x₃,y₃) and (x₄,y₄), then the opening degree of the left eye is:

alpha1=((x1-x2)²+(y1-y2)²)^{0.5}/((x3-x4)²+(y3-y4)²)^{0.5}

At 242, for expression coefficients of the subtle expression, for example, expressions such as raised eyebrows, frown, grin, crooked mouth, and twisted mouth, the expression coefficients obtained by the 3DMM algorithm at 23 are applied.

At 243, for a composite expression, for example, angry, bulge and other expressions, the face image is input to a deep neural network corresponding to the composite expression to obtain the expression coefficient of the composite expression.

At 25, the avatar is driven to make a corresponding expression by applying all the expression coefficients of the face identified at 24.

At 25, when driving the avatar to make the corresponding expression, according to the head posture obtained at 23, a head of the avatar is driven to make a corresponding posture.

Through the method for facial expression recognition according to some embodiments, the user can continuously input a plurality of frames of the images with different expressions through the camera device, to drive the avatar to make expressions, and to drive the three-dimensional virtual character animation by facial animation.

FIG. 3 is a block diagram of an apparatus for facial expression recognition according to an exemplary embodiment. The facial expression recognizing apparatus 300 is used to realize the above-mentioned method for facial expression recognition, the apparatus 300 includes a face detecting unit 31, a determining unit 32, an expression coefficient obtaining unit 33, and an expression recognizing unit 34.

The method for facial expression recognition according to some embodiments may refer to the method shown in the flowcharts of FIG. 2 and FIG. 3, and each unit/module in the device and additional operations and/or functions described above are used to implement the corresponding processes in the method for facial expression recognition shown in FIG. 2 and FIG. 3 to achieve the same or equivalent technical effects. For brevity, details are not repeated here.

In some embodiments, the face detecting unit 31 is configured to obtain a face image by performing face detection on an inputted image, the determining unit 32 is configured to determine expressions classifications in the face image based on an expression classification standard. The expression coefficient obtaining unit 33 is configured to apply different modes to different expressions classifications, to obtain expression coefficients of the expressions classifications of a face in the face image. The expression recognizing unit 34 is configured to recognize an expression of the face based on values of the expression coefficients of the face.

In some embodiments, the expression coefficient obtaining unit 33 includes: a feature point obtaining module, configured to perform recognition on the face image, and obtain a plurality of feature points of the face in the face image; and a single-type expression coefficient obtaining module, configured to determine the individual feature related to the respective single-type expression, and obtain the expression coefficient of the respective single-type expression of the face based on feature points of the individual feature, in which each single-type expression refers to an expression involving a single action unit and a single individual feature of the face. The single-type expressions include at least one of the following: opening eyes, closing eyes, opening mouth, and closing mouth.

In some embodiments, the single-type expression coefficient obtaining module is configured to obtain the expression coefficient of the respective single-type expression by calculating a first degree based on coordinate values of the feature points of the individual feature, in which the first degree includes an opening or closing degree of the individual feature on the face involved by the respective single-type expression.

In some embodiments, the expression coefficient obtaining unit 33 further includes a subtle expression coefficient obtaining module, configured to, perform a three-dimensional reconstruction on the face in the face image by using a three-dimensional face reconstruction method based on the plurality of the feature points of the face, to obtain expression coefficients of the subtle expressions of the face, in which the subtle expressions refer to expressions other than the single-type expressions in expressions each involving the single action unit.

In some embodiments, the expression coefficient obtaining unit 33 further includes: a composite expression coefficient obtaining module, configured to obtain the expression coefficient by inputting the face image into a target deep neural network model. That is, the composite expression coefficient obtaining module inputs the face image into trained target deep neural network models respectively to obtain expression coefficients of the composite expressions of the face, in which each target deep neural network model is corresponding to one composite expression, and each target deep neural network model is configured to identify the expression coefficient of the composite expression corresponding to the target deep neural network model, and each composite expression refers to an expression involving a plurality of action units.

In some embodiments, the target deep neural network model is trained by inputting collected face images into a deep neural network model corresponding to the composite expression and using a determining result on whether the collected face images contain the composite expression.

In detail, the expression coefficient obtaining unit 33 further includes: a model training module, configured to, before the composite expression coefficient obtaining module inputs the face image into the target deep neural network models respectively, for any one of the composite expressions, construct a corresponding deep neural network model, collect a plurality of face images, and input the collected face images into the deep neural network model corresponding to the composite expression, and train the deep neural network model by using a determining result on whether the face in the face image has the composite expression as an output of the deep neural network model, to obtain a trained target deep neural network model.

In some embodiments, the apparatus further includes: an expression driving unit, configured to, drive an avatar to make a corresponding expression according to the expression coefficients of the face; and/or optimize a three-dimensional face model of the face obtained through a three-dimensional reconstruction, based on the expression coefficients of the face.

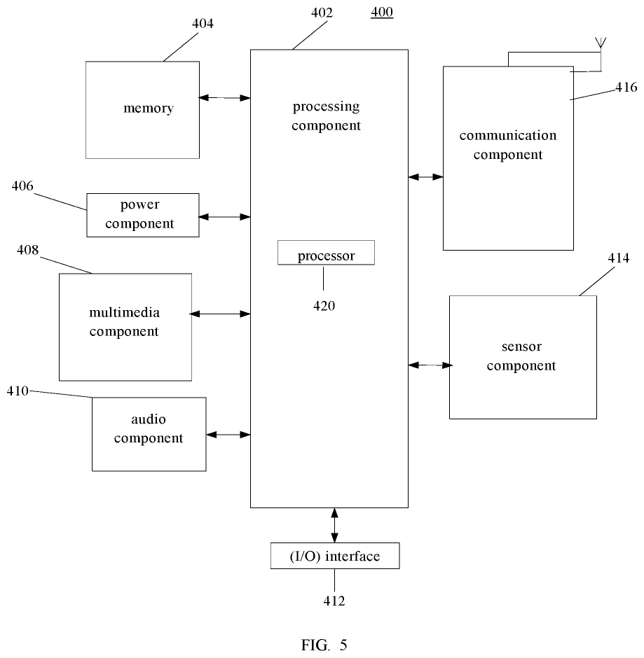

FIG. 5 is a block diagram of an apparatus 400 for facial expression recognition according to an embodiment. For example, the apparatus 400 may be a mobile phone, a computer, a digital broadcasting terminal, a messaging device, a game console, a tablet device, a medical device, a fitness device, and a personal digital assistant.

As illustrated in FIG. 5, the apparatus 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the apparatus 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the apparatus 400. Examples of such data include instructions for any applications or methods operated on the apparatus 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the apparatus 400. The power component 406 may include a power management system, one or more power sources, and any other components associated with the generation, management, and distribution of power in the apparatus 400.

The multimedia component 408 includes a screen providing an output interface between the apparatus 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera and/or a rear camera. When the apparatus 400 is in an operation mode, such as a shooting mode or a video mode, the front camera and/or the rear camera may receive external multimedia data. Each front camera and rear camera can be a fixed optical lens system or have focal length and optical zoom capabilities.

The audio component 410 is configured to output and/or input audio signals. For example, the audio component 410 includes a microphone (“MIC”) configured to receive an external audio signal when the apparatus 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the apparatus 400. For instance, the sensor component 414 may detect an open/closed status of the apparatus 400, relative positioning of components, e.g., the display and the keypad, of the apparatus 400, a change in position of the apparatus 400 or a component of the apparatus 400, a presence or absence of user contact with the apparatus 400, an orientation or an acceleration/deceleration of the apparatus 400, and a change in temperature of the apparatus 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may further include an acceleration sensor, a gyro sensor, a magnetic sensor, a pressure sensor, or a temperature sensor.

The communication component 416 is configured to facilitate communication, wired or wirelessly, between the apparatus 400 and other devices. The apparatus 400 can access a wireless network based on a communication standard, such as WiFi, 2G, or 3G, or a combination thereof. In some embodiments, the communication component 416 receives a broadcast signal or broadcast associated information from an external broadcast management system via a broadcast channel. In some embodiments, the communication component 416 further includes a near field communication (NFC) module to facilitate short-range communications. For example, the NFC module may be implemented based on a radio frequency identity (RFID) technology, an infrared data association (IrDA) technology, an ultra-wideband (UWB) technology, a Bluetooth (BT) technology, and other technologies.

In some embodiments, the apparatus 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, a storage medium including instructions is provided, such as the memory 404 including instructions, and the foregoing instructions may be executed by the processor 420 of the apparatus 400 to complete the foregoing method. In some embodiments, the storage medium may be a non-transitory computer-readable storage medium, for example, the non-transitory computer-readable storage medium may be a ROM, a random access memory (RAM), a CD-ROM, a magnetic tape, a floppy disk, and an optical data storage device.

In some embodiments, a computer program product is also provided. The computer program product includes readable program codes. The readable program codes may be executed by the processor 420 of the apparatus 400 to complete the facial expression recognizing method described in any of the embodiments. In some embodiments, the program codes may be stored in a storage medium of the apparatus 400, and the storage medium may be a non-transitory computer-readable storage medium. For example, the non-transitory computer-readable storage medium may be a ROM or a random access memory (RAM), a CD-ROM, a magnetic tape, a floppy disk and an optical data storage device.

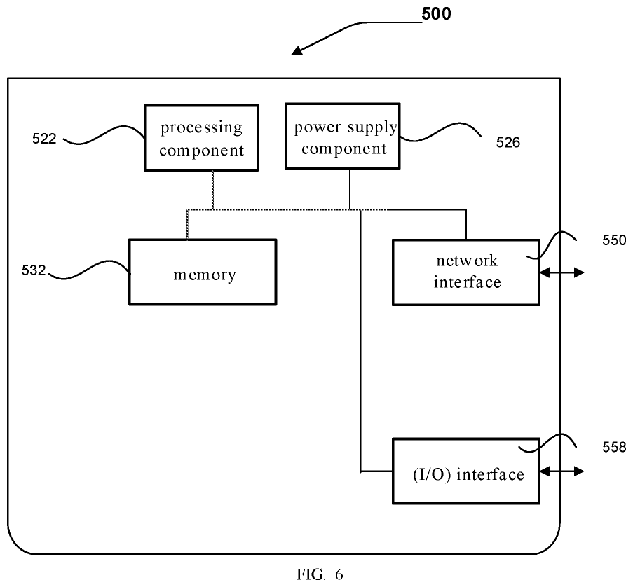

FIG. 6 is a block diagram of an apparatus 500 for facial expression recognition according to an embodiment. For example, the apparatus 500 may be provided as a server.

As illustrated in FIG. 6, the apparatus 500 includes a processing component 522, which further includes one or more processors, and a memory resource represented by a memory 532 for storing instructions executable by the processing component 522, such as application programs. The application program stored in the memory 532 may include one or more modules each corresponding to a set of instructions. In addition, the processing component 522 is configured to execute instructions to execute the facial expression recognizing method described in any embodiment.

The apparatus 500 may also include a power supply component 526 configured to perform power management of the apparatus 500, a wired or wireless network interface 550 configured to connect the apparatus 500 to a network, and an input/output (I/O) interface 558. The apparatus 500 may operate an operating system stored in the memory 532, such as Windows Server™, Mac OS X™, Unix™, Linux™, and FreeBSD™.

It will be understood that, the flow chart or any process or method described herein in other manners may represent a module, segment, or portion of code that comprises one or more executable instructions to implement the specified logic function(s) or that comprises one or more executable instructions of the steps of the progress. Although the flow chart shows a specific order of execution, it is understood that the order of execution may differ from that which is depicted. For example, the order of execution of two or more boxes may be scrambled relative to the order shown.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

Those skilled in the art easily think of other embodiments of the present disclosure after considering the description and practicing the disclosure disclosed herein. This disclosure is intended to cover any variations, uses, or adaptive changes that follow the general principles of this disclosure and include common general knowledge or customary technical means in the technical field not disclosed in this disclosure. The description and examples are to be considered exemplary only, and the true scope and spirit of this disclosure are pointed out in the claims.

It should be understood that the present disclosure is not limited to the precise structure that has been described above and shown in the drawings, and various modifications and changes can be made without departing from the scope thereof. The scope of the present disclosure is limited only by the appended claims.

What is claimed is:

1. A method for facial expression recognition, comprising:
obtaining a face image by detecting an inputted image;
determining expression classifications in the face image based on an expression classification standard;
obtaining expression coefficients of the expression classifications; and
recognizing expressions in the face image based on the expression coefficients.

2. The method according to claim 1, wherein the expression classifications comprise a single-type expression, a subtle expression and a composite expression, the single-type expression involves a single moving unit and an individual feature of the face image; the subtle expression refers to an expression involving the single moving unit other than the single-type expression; the composite expression involves a plurality of action units.

3. The method according to claim 2, wherein in response to the expression classification being the single-type expression, obtaining the expression coefficient comprises:
obtaining feature points of the face image;
determining the individual feature related to the single-type expression; and
obtaining the expression coefficient based on feature points related to the individual feature.

4. The method according to claim 3, wherein the obtaining the expression coefficient comprises:
calculating a first degree based on coordinate values of the feature points related to the individual feature, wherein the first degree comprises an opening or closing degree of the individual feature; and
obtaining the expression coefficient based on the first degree.

5. The method according to claim 2, wherein in response to the expression classification being the subtle expression, obtaining the expression coefficient comprises:
obtaining feature points of the face image; and
obtaining the expression coefficient by performing a three-dimensional reconstruction on the face image based on the feature points.

6. The method according to claim 2, wherein in response to the expression classification being the composite expression, obtaining the expression coefficient comprises:
obtaining the expression coefficient by inputting the face image into a target deep neural network model.

7. The method according to claim 6, wherein the target deep neural network model is trained by inputting collected face images into a deep neural network model corresponding to the composite expression and using a determining result on whether the collected face images contain the composite expression.

8. The method according to claim 1, further comprising:
driving an avatar to make a corresponding expression based on the expression coefficients.

9. The method according to claim 1, further comprising:
optimizing a three-dimensional face model corresponding to the face image based on the expression coefficients.

10. An apparatus for facial expression recognition, comprising:
one or more processors;
a memory coupled to the one or more processors,
a plurality of instructions stored in the memory, when executed by the one or more processors, cause the one or more processors perform acts comprising:
obtaining a face image by detecting an inputted image;
determining expression classifications in the face image based on an expression classification standard;
obtaining expression coefficients of the expression classifications; and
recognizing expressions in the face image based on the expression coefficients.

11. The apparatus according to claim 10, wherein the expression classifications comprise a single-type expression, a subtle expression and a composite expression, the single-type expression involves a single moving unit and an individual feature of the face image; the subtle expression refers to an expression involving the single moving unit other than the single-type expression; the composite expression involves a plurality of action units.

12. The apparatus according to claim 11, wherein in response to the expression classification being the single-type expression, the one or more processors obtain the expression coefficient by performing acts of:
obtaining feature points of the face image;
determining the individual feature related to the single-type expression; and
obtaining the expression coefficient based on feature points related to the individual feature.

13. The apparatus according to claim 12, wherein the one or more processors obtain the expression coefficient by performing acts of:
calculating a first degree based on coordinate values of the feature points related to the individual feature, wherein the first degree comprises an opening or closing degree of the individual feature; and
obtaining the expression coefficient based on the first degree.

14. The apparatus according to claim 11, wherein in response to the expression classification being the subtle expression, the one or more processors obtain the expression coefficient by performing acts of:
obtaining feature points of the face image; and
obtaining the expression coefficient by performing a three-dimensional reconstruction on the face image based on the feature points.

15. The apparatus according to claim 11, wherein in response to the expression classification being the composite expression, the one or more processors obtain the expression coefficient by performing an act of:
obtaining the expression coefficient by inputting the face image into a target deep neural network model.

16. The apparatus according to claim 15, wherein the target deep neural network model is trained by inputting collected face images into a deep neural network model corresponding to the composite expression and using a determining result on whether the collected face images contain the composite expression.

17. The apparatus according to claim 10, wherein the one or more processors are further caused to perform at least one act of:
driving an avatar to make a corresponding expression based on the expression coefficients.

18. The apparatus according to claim 10, wherein the one or more processors are further caused to perform at least one act of:
optimizing a three-dimensional face model corresponding to the face image based on the expression coefficients.

19. A non-transitory computer-readable storage medium, wherein when an instruction stored therein is executed by a processor in an electronic device, the processor is caused to perform acts comprising:
obtaining a face image by detecting an inputted image;
determining expression classifications in the face image based on an expression classification standard;
obtaining expression coefficients of the expression classifications; and
recognizing expressions in the face image based on the expression coefficients.

20. The non-transitory computer-readable storage medium according to claim 19, wherein in response to the expression classification being a single-type expression, obtaining the expression coefficient comprises:
obtaining feature points of the face image;
determining the individual feature related to the single-type expression; and
obtaining the expression coefficient based on feature points related to the individual feature.
